(19) United States
(12) Patent Application Publication
(10) Pub. No.: US 2004/0046277 A1
(43) Pub. Date: Mar. 11, 2004

(54) Protein shaped body and method for the production thereof according to the nmmo method

(76) Inventors: Horst Buerger, Rudolstadt (DE); Eberhard Taeger, Rudolstadt (DE); Markus Eilers, Wietmarschen-Lohne (DE); Klaus Berghof, Rudolstadt (DE)

Correspondence Address: Klaus Schweitzer, ProPat, Crosby Building, 2912 Crosby Road, Charlotte, NC, 28211-2815, US

(21) Appl. No.: 10/432,420

(22) PCT Filed: Nov. 24, 2001
(86) PCT No.: PCT/DE01/04436

(30) Foreign Application Priority Data
Nov. 28, 2000 (DE) 100 59 111.6

(51) Int. Cl. D01F 4/00; B29C 39/14; B29C 47/14

(52) U.S. Cl. 264/186; 264/202; 264/233; 264/217; 525/54.1; 525/54.3

(57) ABSTRACT

This invention relates to a method for producing proteinaceous shaped articles from globular proteins according to the NMMO method, and to proteinaceous shaped articles themselves that are made from globular proteins according to the NMMO method. According to the invention, a suspension consisting of aqueous NMMO and of these precrosslinked proteins is transferred into a spinning solution, whereby the suspension contains a polysaccharide and/or a polysaccharide is added to the extrusion solution. The spinning solution is extruded into a precipitation bath through a form tool and through an air gap. Afterwards, the shaped article is washed with an aqueous liquid without the use of solvents and is subsequently hardened using known crosslinking reactions. The produced solutions are processed for a diverse product-oriented processing, preferably on the basis of known wet and dry/wet spinning techniques, optionally in conjunction with multi-constituent spinning techniques. The produced solutions can be processed using spin casting or other shaping techniques in order to produce, by these means, e.g. monofil and polyfil filaments, staple fibers, microfibers, nonwovens, foils, membranes, coatings, films or other shaped articles.

### BACKGROUND OF THE INVENTION

1. Field of the Invention

This invention relates to a process for producing proteinaceous shaped articles from globular proteins by the NMMO process and also to proteinaceous shaped articles formed from globular proteins by the NMMO process. Globular proteins for the purposes of this invention are proteins which have a spherical tertiary structure and are soluble in water and/or salt solutions. Examples thereof include casein (milk protein), zein (maize protein) and ardein (peanut protein). Proteinaceous shaped articles as used hereinbelow refers to shaped articles comprising globular protein.

2. Description of the Related Art

The production of regenerated protein fibers by dissolving proteins and spinning these solutions directly into a coagulation bath (wet spinning) or into an environmentally conditioned free-fall cell (dry spinning, CH 232,342) has long been known. Historically, dry spinning was distinctly less prominently pursued than wet spinning. The first protein fiber was produced from gelatin by A. Millar in 1894 (Vandura), and he patented casein fibers from casein dissolved in glacial acetic acid in U.S. Pat. No. 625,345. F. Todtenhaupt found aqueous sodium hydroxide solution to be a significantly cheaper and more easily handled solvent for casein and coagulated the threads in a coagulation bath which contained formaldehyde as a fiber stabilizer as well as sulfuric acid and Glauber's salt (DE 170,051; DE 178,985; DE 183,317; DE 203,820). The first process to become industrially important was the Lanital process (GB 483,731; FR 813,427; U.S. Pat. No. 2,297,397; U.S. Pat. No. 2,338,916) whereby casein (obtained by acid treatment of milk) was dissolved in dilute aqueous sodium hydroxide solution and subsequently spun into a sulfuric acid acidified coagulation bath. The fibers/filaments are hardened by treatment in a formaldehydic hardening bath. As well as casein, other proteins, for example from maize, peanut, soybean, cottonseed and fish protein, can be used as a raw material.

As well as all-protein fibers, wet spinning can also be used to produce shaped products from mixtures of a casein solution and a cellulose xanthate solution, and also mineralized casein fibers by addition of sodium silicate or potassium silicate solution or of a solution of alkali-soluble metal salts, such as zinc or aluminum compounds (GB 483,731; U.S. Pat. No. 2,548,357). U.S. Pat. No. 2,211,961 describes using dilute ammonia solution instead of dilute aqueous sodium hydroxide solution as a solvent. Furthermore, (GB 684,506) discloses a process whereby proteins are dissolved in dichloroacetic or trichloroacetic acid and coagulated in pure water or in methanol, ethanol or aqueous ethanol.

Proteinaceous shaped articles need to be hardened after coagulation in order that the polypeptide chains which have been oriented by stretching may be set through cross links. Useful hardening agents, as well as formaldehyde, include other aldehydes and dialdehydes and also, for example, aluminum sulfate, formamide, dimethylolurea. In addition, various processes are described in the literature for an additional stabilization of the fibers. This can be effected through an acetylation, through a formaldehyde treatment, through a treatment with silicon halides, through a mineral tanning operation, through deamination or through an esterification (GB 690,492). Features common to all these processes are the high number of process steps and also the use of chemicals which are in some instances not generally recognized as safe, which create high manufacturing and capital investment costs and which necessitate costly and inconvenient facilities for complying with statutory mandates to lessen environmental impact.

The production of cellulosic shaped articles by dissolving cellulose in the tertiary amine oxide N-methylmorpholine N-oxide (NMMO) and spinning these solutions through an air gap into an aqueous coagulation bath has been extensively described (eg U.S. Pat. No. 4,246,221, DE 42 19 658, DE 42 44 609, DE 43 43 100, DE 44 26 966). A process of the aforementioned kind will hereinbelow be referred to as “amine oxide process”. Cellulose fibers and filaments formed by this process have been granted the generic name LYOCELL by BISFA. The advantages of the amine oxide process over the established viscose process are, first, the distinctly fewer number of process steps and, secondly, the fact that no environmentally harmful emissions arise. This is particularly due to the use of the nontoxic solvent NMMO, which is >99% recoverable.

The ability of tertiary amine oxides to dissolve natural and also, in some instances, synthetic polymers and monomers under certain conditions is known from U.S. Pat. No. 3,447,939, where N-methylmorpholine N-oxide is presented as one of a number of possible solvents for proteins. The cited patent relates to a solution comprising a natural or synthetic polymeric or monomeric compound, at a weight fraction of up to 70%, in one of the solvents N-methylmorpholine N-oxide, N-methylpiperidine N-oxide, N-methylpyrrolidine N-oxide or N-methylazacycloheptane N-oxide, and also to a process for preparing the aforementioned solution. The solvents are used in anhydrous form and the production of specific shaped articles and process design features are not disclosed.

In addition, DE 198 41 649 discloses a process for preparing concentrated solutions of fibrillar proteins in NMMO monohydrate and also their product-oriented processing. Globular proteins, which occur in nature in large numbers and are frequently simple to recover, are excluded, however.

### SUMMARY OF THE INVENTION

It is an object of this invention to provide a process whereby proteinaceous shaped articles are preparable in distinctly fewer steps and in an environmentally friendlier manner than hitherto.

This object is achieved according to this invention by a process for producing proteinaceous shaped articles, which comprises converting a suspension of aqueous NMMO and globular proteins into a spinning solution, extruding this spinning solution through shaping means and through an air gap into a coagulation bath, then washing the shaped article free of solvent with aqueous liquid and subsequently hardening it through known crosslinking reactions. Additional stabilization through known processes is possible.

It was surprisingly found that globular proteins, after dissolution in aqueous NMMO, are processible into proteinaceous shaped articles in an extremely environment-friendly manner by using the equipment used for producing cellulosic shaped articles in the amine oxide process.

### DETAILED DESCRIPTION OF THE PREFERRED EMBODIMENTS

In a preferred embodiment of the process according to the invention, the globular protein used is already precrosslinked through known crosslinking reactions, such as for example by aldehydes and dialdehydes and also for example aluminum sulfate, formamide, dimethylolurea et al, and the hardening/crosslinking of the shaped articles after extrusion can then be alternatively omitted. The crosslinking reaction or reactions advantageously take place in the presence of Lewis acids which serve as a catalyst for the crosslinking reaction. The crosslinking reaction or reactions are advantageously carried out at temperatures between 0 and 160° C. The reactive groups for the crosslinking reaction or reactions are not just the extra amino groups and any acid amide groups present, but also the imino groups of the peptide bond and also the hydroxyl groups of serine. Cross links through sulfur bridges or by means of benzoquinone are also possible. A specifically targeted precrosslinking of the protein distinctly reduces the solubility in water and/or salt solutions without significantly influencing the solubility in NMMO. It has further been determined that the proteins are capable, through their reactive groups, of stabilizing the solvent against thermal decomposition, indicated for example by less discoloration of the extrusion solution compared with solutions of cellulose for example. It is believed that known decomposition products of the solvent, such as formaldehyde for example, react with the reactive groups and are thus scavenged away, so that they are no longer available for secondary decomposition reactions.

In a particularly preferred embodiment of the process according to the invention, a polysaccharide is added to the suspension and/or the extrusion solution to modify the properties of the shaped article to be produced. In this particularly preferred embodiment of the process according to the invention, 0.5 to 99.5% by mass and preferably 60 to 95% by mass of protein(s) and 0.5 to 99.5% by mass and preferably 40 to 5% by mass of polysaccharide(s) are used, based on the total mass of dissolved compounds.

In the particularly preferred embodiment of the process according to the invention, one or more globular proteins are used and the polysaccharide used is one or more polysaccharides and/or polysaccharide derivatives which are constructed from hexoses by glycosidic 1,4- and 1,6-linkage or at least to some extent from uronic acid(s), preferably cellulose. As well as cellulose, it is possible to use water-insoluble or water-soluble homopolysaccharides and/or homopolysaccharide derivatives which are constructed of unitary basic units linked together differently, and also heteropolysaccharides which, as well as unitary chain basic building blocks, possess different building blocks, preferably attached as a side chain. Examples of homopolysaccharides are starches, pullulan and hyaluronic acid, examples of heteropolysaccharides are pectin, algin, carrageenan, xanthan, carubin and guaran and examples of homopolysaccharide derivatives are chitosan, carboxymethylchitosan, carboxymethylcellulose or cellulose acetate.

It is advantageous to activate the optionally precrosslinked protein and the polysaccharide prior to forming the spinning solution. This can be accomplished by swelling in water, in aqueous NMMO, in liquid ammonia and/or by means of a suitable enzyme system.

As well as a polysaccharide being added to the suspension and/or to the spinning solution, the suspension and/or spinning solution may also be admixed with other low and/or high molecular weight organic and/or inorganic substances which are soluble in NMMO monohydrate and/or dispersed therein sufficiently finely. It is thus possible for example to add carbon black, ion exchangers, metal oxides, metal carbides, metal silicates, metal nitrides, metal salts and/or metal sulfates having low particle sizes to the suspension and/or spinning solution, for example in order to speed the dissolving process and/or color the solution and/or improve the colorability and/or reduce the foaming of the solutions and/or enhance the thermal stability of the solution and/or achieve antiseptic and/or fungicidal effects and/or improve the wettability of surfaces and/or in order, after the processing of the solutions, to achieve desired product properties, such as for example color and/or luster and/or mattness and/or electrical conductivity and/or antistatic behavior and/or sensory properties and/or improved light and/or higher thermal stability and/or porous structures and/or influenceable adsorption and/or desorption properties and/or detectability by and/or contrast-improving action on particle irradiation and/or magnetic and/or optical properties and/or a specific separation capacity and/or improved mechanical properties.

Furthermore, the proteins can be dissolved together with synthetic polymers which are soluble in NMMO monohydrate, such as for example poly(N-vinylpyrrolidone), polyvinyl alcohol or polyethylene oxide. Thus produced spinning solutions can be processed according to the present invention by the familiar wet or dry/wet spinning processes in an enivronmentally friendly manner and in few process steps into a wide variety of shaped articles, such as fibers, filaments and films. Further diverse product-oriented processing operations are possible as well, such as for example shear coagulation produced microfibers, fibrids and nonwovens. These products in their totality can in turn be put to diverse uses.

The examples which follow illustrate the invention.

### EXAMPLES

### Examples 1

100 g of zein are dispersed in 250 ml of water and crosslinked by addition of 2 g of glutaraldehyde and 0.1 g of MgCl₂ at 25° C. After pressing off to a moisture content of 50%, the zein is suspended in 430 g of 60% aqueous NMMO. 0.5 g of propyl gallate is added as a stabilizer. This suspension is converted into a spinning solution in a jacket-heated kneading apparatus under a vacuum of 30 mbar at a temperature of 90° C. by distillative removal of 130 g of H₂O. The spinning solution was examined for homogeneity under the optical microscope, and found to be homogeneous 15 min after the distillation had ended.

This residueless spinning solution was extruded through a die as filaments through an air gap into an aqueous coagulation bath (spinning temperature: 80° C.; orifice: 90 μm; number of capillaries: 150; air gap: 15 mm). The filaments were then washed with distilled H₂O until solvent free and cut into fibers (40 mm). These fibers were subsequently hardened in a 0.5% glutaraldehyde solution in the presence of MgCl₂ at 25° C. and subsequently dried at 60° C. in a circulating air drying cabinet.

### Example 2

50 g of casein are dispersed in 250 ml of water and crosslinked by addition of 1 g of glutaraldehyde and 0.1 g of MgCl₂ at 25° C. After pressing off to a moisture content of 50%, the casein is suspended in 430 g of 60% aqueous NMMO. In addition, 25 g (bone dry) of ground sulfite pulp (DP 760) are added to the suspension. 0.5 g of propyl gallate was added as a stabilizer. This suspension is converted into a spinning solution in a jacket-heated kneading apparatus under a vacuum of 30 mbar at a temperature of 90° C. by distillative removal of 140 g of H₂O. The spinning solution was examined for homogeneity under the optical microscope, and found to be homogeneous 15 min after the distillation had ended.

This residueless spinning solution was extruded through a die through an air gap into an aqueous coagulation bath (spinning temperature: 80° C.; hole diameter: 90 μm; number of capillaries: 150; air gap: 15 mm). The fiber tow was then washed with distilled H₂O until solvent free and cut into fibers (40 mm) and subsequently dried at 60° C. in a circulating air drying cabinet.

### Example 3

75 g of ardein are dispersed in 250 ml of water and crosslinked by addition of 1 g of glutaraldehyde and 0.1 g of MgCl₂ at 25° C. After pressing off to a moisture content of 50%, the ardein is suspended in 430 g of 60% aqueous NMMO. In addition, 15 g (bone dry) of ground sulfite pulp (DP 760) are added to the suspension. 0.5 g of propyl gallate was added as a stabilizer. This suspension is converted into a spinning solution in a jacket-heated kneading apparatus under a vacuum of 30 mbar at a temperature of 90° C. by distillative removal of 125 g of H₂O. The spinning solution was examined for homogeneity under the optical microscope, and found to be homogeneous 15 min after the distillation had ended. This residueless spinning solution was extruded through a die through an air gap into an aqueous coagulation bath (spinning temperature: 80° C.; hole diameter: 90 μm; number of capillaries: 150; air gap: 15 mm). The fiber tow was then washed with distilled H₂O until solvent free and cut into fibers (40 mm). These fibers were subsequently hardened in 0.5% glutaraldehyde solution in the presence of MgCl₂ at 25° C. and additionally stabilized by esterification in an aqueous bath containing 4% of concentrated H₂SO₄ and 33% of ethanol. The fibers were subsequently dried at 60° C. in a circulating air drying cabinet.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

The priority document, German Patent Application No. 100 59 111.6, filed Nov. 28, 2000 is incorporated herein by reference in its entirety.

As used herein and in the following claims, articles such as “the”, “a” and “an” can connote the singular or plural.

All documents referred to herein are specifically incorporated herein by reference in their entireties.

We claim:

1. A process for producing proteinaceous shaped articles, which comprises converting a suspension of aqueous amine oxide and at least one optionally precrosslinked globular protein into an extrusion solution, the suspension containing a polysaccharide or adding a polysaccharide to the extrusion solution or both, extruding said extrusion solution through shaping means and through an air gap into a coagulation bath and washing the coagulated shaped article.

2. A process as claimed in claim 1, wherein said amine oxide is N-methylmorpholine N-oxide.

3. A process as claimed in claim 1, wherein said proteinaceous shaped article is subsequently hardened.

4. A process as claimed in claim 1, wherein from 0.5 to 99.5% by mass of protein and from 0.5 to 99.5% by mass of polysaccharide are used, based on the total mass of dissolved compounds.

5. A process as claimed in claim 4, wherein from 60 to 95% by mass of protein and from 40 to 5% by mass of polysaccharide are used, based on the total mass of dissolved compounds.

6. A process as claimed in claim 1, wherein said polysaccharide is at least one polysaccharide or a derivative thereof, which is constructed from hexoses by glycosidic 1,4- and 1,6-linkage or at least to some extent from uronic acid(s).

7. A process as claimed in claim 1, wherein said polysaccharide comprises a water-soluble homo- or heteropolysaccharide or a derivative thereof.

8. A process as claimed in claim 1, wherein Lewis acids are used as catalysts for the crosslinking of said protein.

9. A process as claimed in claim 1, wherein said protein is crosslinked through its amino groups, amide groups, imino groups of the peptide bond, hydroxyl groups of serine, cystine building block or a combination thereof.

10. A process as claimed in claim 3, wherein said subsequent hardening is effected by means of crosslinking, through an additional stabilization by an acetylation, a treatment with aldehydes or dialdehydes or a mixture thereof, a treatment with silicon halides, a mineral tanning operation, a deamination, an esterification or a combination thereof.

11. A process as claimed in claim 10, wherein said crosslinking, said additional stabilization or both take place at a temperature between 0 and 160° C.

12. A process as claimed in claim 11, wherein said crosslinking, said additional stabilization or both take place at a temperature between 15 and 60° C.

13. A process as claimed in claim 1, wherein the dissolving step is speeded by preactivating said globular proteins and said polysaccharides by swelling them in suitable media, by treating them with an enzyme system or a combination thereof.

14. A process as claimed in claim 13, wherein said media suitable for swelling comprise water, aqueous solutions of NMMO, liquid ammonia or any combination thereof, and said enzyme system comprises hydrolases.

15. A process as claimed in claim 1, wherein further organic low molecular weight compounds, organic high molecular weight compounds, inorganic substances or any combination thereof are added to the suspension, to the extrusion solution or to both, said organic compounds or inorganic substances being soluble or dispersible in NMMO monohydrate.

16. A process as claimed in claim 15, wherein said inorganic substances are sulfates or other salts, silicates, carbon black or oxides, nitrides or carbides or combinations thereof.

17. A process as claimed in claim 15, wherein said organic low molecular weight substances are selected from the group consisting of dyes, dyeing assistants, flame retardants, stabilizers which are customarily used to protect against any polymer degradation processes, substances which favorably influence the application conditions or the processing conditions or both of the extrusion solutions, surfactants and additives which improve or influence the application characteristics, the performance characteristics or both of the products produced therefrom in turn, reactive bifunctional or multifunctional crosslinkers, photosensitizers and biologically active substances, and wherein the low molecular weight organic substances are dissolved or dispersed in NMMO monohydrate.

18. A process as claimed in claim 17, wherein said substances which favorably influence the application conditions or the processing conditions or both of the extrusion solution comprise spin finishes.

19. A process as claimed in claim 17, wherein said additives which improve or influence the application characteristics, the performance characteristics or both of the products produced therefrom in turn comprise adhesion promoters.

20. A process as claimed in claim 15, wherein said organic high molecular weight substances comprise synthetic polymers which are dissolved or dispersed in NMMO monohydrate.

21. A process as claimed in claim 20, wherein said organic high molecular weight substances are selected from the group consisting of poly(N-vinylpyrrolidone), polyvinyl alcohol and polyethylene oxide.

22. A process as claimed in claim 1, wherein said extrusion solution is processed on the basis of known wet and dry/wet spinning technologies.

23. A process as claimed in claim 22, wherein said extrusion solution is processed on the basis of known wet and dry/wet spinning technologies in combination with multicomponent spinning technologies.

24. A process as claimed in claim 1, wherein said extrusion solution is processed by spinning, casting or other shaping technologies.

25. A process as claimed in claim 1, wherein said extrusion solution is processed into mono- and polyfil filaments, staple fibers, microfibers, nonwovens, foils, membranes, coatings, films or other shaped articles that are further processed alone or in admixture into textile fabrics for apparel articles and personal protection, into bonding fibers for web consolidation and for reinforcement in biocomposites and polymeric films, of reinforcing fibers for fiber-reinforced composite materials and composites, into producing leather imitations, paper, filters, membranes and adsorption materials, hygiene articles, cosmetic additives and materials for wound management or biomaterials for artificial skin, for implants and prostheses or for coating thereon, for tissue engineering and also for chromatographic separation and substrate materials.

26. A proteinaceous shaped article produced as claimed in claim 1.
